(19) United States
(12) Patent Application Publication
(10) Pub. No.: US 2026/0312322 A1
(43) Pub. Date: Oct. 8, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yicheng CHEN, Mie (JP); Teruo HARA, Mie (JP)

(21) Appl. No.: 19/476,172

(22) PCT Filed: Apr. 5, 2024
(86) PCT No.: PCT/JP2024/014119

§ 371 Date: Oct. 17, 2025

(30) Foreign Application Priority Data
Apr. 26, 2023 (JP) 2023-072143

(51) Int. Cl. H01R 13/422; H01R 12/72

(52) U.S. Cl. CPC H01R 13/422; H01R 12/722

(57) ABSTRACT

A connector includes a housing including a holding wall portion formed with a press-fitting hole penetrating through the holding wall portion. A terminal fitting includes a board connecting portion to be surface-mounted on a circuit board, and is press-fit into the press-fitting hole from behind. The press-fitting hole includes a reference width portion and a wide width portion having a larger dimension in a width direction than a reference width portion and constituting a rear end part of the press-fitting hole. The terminal fitting includes a narrow portion to be accommodated into the reference width portion and a wide portion to be accommodated into a wide width portion.

### TECHNICAL FIELD

The present disclosure relates to a connector.

### BACKGROUND

A connector disclosed in Patent Document 1 includes a terminal insertion hole (hereinafter, also referred to as a press-fitting hole), through which a terminal fitting is press-fit from behind, in a back wall (hereinafter, a holding wall portion) of a housing. A rear end part of the press-fitting hole is formed with a conically open guiding edge. The terminal fitting has a position shift corrected by sliding in contact with the guiding edge, and press-fit into a terminal inserting portion. The terminal fitting includes a connecting portion (hereinafter, referred to as a board connecting portion) projecting outward from the housing and to be connected to a board formed on a surface of a circuit board.

### PRIOR ART DOCUMENT

### Patent Document

Patent Document 1: JP 2007-122923 A

### SUMMARY OF THE INVENTION

### Problems to be Solved

In the connector as described above, the board connecting portion, which is a rear end part of the terminal fitting, is soldered and connected to the circuit board by way of a reflow process. Here, the holding wall portion is held in close contact with the terminal fitting only in a region in front of a guide of the terminal fitting. Thus, when the housing thermally expands and is deformed in the reflow process, the terminal fitting may be inclined with respect to a back wall. If the posture of the terminal fitting is inclined, there is a concern that the board connecting portion is lifted up from the circuit board and causes a connection failure.

A problem of the present disclosure is solved by providing a connector capable of suppressing the inclination of a terminal fitting with respect to a housing in a reflow process.

### Means to Solve the Problem

The present disclosure is directed to a connector with a housing made of synthetic resin, the housing including a holding wall portion formed with a press-fitting hole in the form of a through hole, and a terminal fitting including a board connecting portion to be surface-mounted on a circuit board, the terminal fitting being press-fit into the press-fitting hole from behind the holding wall portion, the press-fitting hole including a reference width portion constituting a front end region of the press-fitting hole and a wide width portion having a larger dimension in a width direction than the reference width portion, the wide width portion constituting a rear end part of the press-fitting hole, the terminal fitting including a narrow portion to be accommodated into the reference width portion and a wide portion to be accommodated into a wide width portion, and an inner surface of the reference width portion and an inner surface of the wide width portion being formed with inclination suppressing portions for suppressing inclination of the terminal fitting with respect to the holding wall portion by contacting an outer surface of the terminal fitting in a direction intersecting the width direction.

### Effect of the Invention

According to the connector of the present disclosure, the inclination of the terminal fitting with respect to the housing can be suppressed in a reflow process.

### BRIEF DESCRIPTION OF THE DRAWINGS

FIG. 1 is a perspective view of a connector of one embodiment.

FIG. 2 is a side view in section of the connector of the embodiment.

FIG. 3 is a plan view in section of the connector of the embodiment.

FIG. 4 is an enlarged back view showing a rear end part of a press-fitting hole of the connector of the embodiment.

FIG. 5 is a back view of the connector of the embodiment not accommodating terminal fittings.

FIG. 6 is a front view of the connector of the embodiment not accommodating the terminal fittings.

FIG. 7 is an enlarged back view showing the rear end part of the press-fitting hole of the connector of the embodiment not accommodating the terminal fittings.

FIG. 8 is an enlarged front view showing a front end part of the press-fitting hole of the connector of the embodiment not accommodating the terminal fittings.

FIG. 9 is an enlarged perspective view showing the rear end part of the press-fitting hole of the connector of the embodiment not accommodating the terminal fittings when viewed from behind.

### DETAILED DESCRIPTION TO EXECUTE THE INVENTION

### Description of Embodiments of Present Disclosure

(1) The connector of the present disclosure is provided with a housing made of synthetic resin and including a holding wall portion formed with a press-fitting hole in the form of a through hole. A terminal fitting includes a board connecting portion to be surface-mounted on a circuit board, and is press-fit into the press-fitting hole from behind the holding wall portion. The press-fitting hole includes a reference width portion constituting a front end region of the press-fitting hole and a wide width portion having a larger dimension in a width direction than the reference width portion and constituting a rear end part of the press-fitting hole. The terminal fitting includes a narrow portion to be accommodated into the reference width portion and a wide portion to be accommodated into a wide width portion. An inner surface of the reference width portion and an inner surface of the wide width portion are formed with inclination suppressing portions for suppressing inclination of the terminal fitting with respect to the holding wall portion by contacting an outer surface of the terminal fitting in a direction intersecting the width direction.

Since the inclination suppressing portions of the connector of the present disclosure are formed not only in the front end region of the press-fit hole, but also in the wide width portion located in the rear end part of the press-fit hole, a long contact length with the terminal fitting in a front-rear direction is ensured as compared to the case where the inclination suppressing portions are formed only in the front end region of the press-fit hole. In this way, when the housing thermally expands in a reflow process, the inclination of the terminal fitting with respect to a protection wall portion can be effectively suppressed.

(2) In the connector of (1), a tapered guiding surface is formed on a rear end part of the inclination suppressing portion. According to this configuration, the terminal fitting shifted in position with respect to the press-fit hole can be guided into the press-fit hole by the tapered guiding surfaces.

(3) In the connector of (1) or (2), the inclination suppressing portions are formed only on both end parts in the width direction of the inner surfaces. Recesses configured not to contact the terminal fitting are formed in central parts in the width direction of the inner surfaces. According to this configuration, when the terminal fitting is press-fit into the press-fit hole, the central parts in the width direction of the inner surfaces do not contact the terminal fitting. Thus, the amount of resin adhering to the terminal fitting can be suppressed and a connection failure to a mating terminal due to resin adhesion to the terminal fitting can be prevented as compared to the case where the inclination suppressing portions contact the terminal fitting over the entire widths of the inner surfaces.

(4) In the connector of any one of (1) to (3), the recess is continuously formed over an entire length in a press-fitting direction of the press-fitting hole. According to this configuration, since the terminal fitting and the recesses are not in contact over the entire lengths of the arranged inclination suppressing portions in the press-fitting direction of the press-fit hole, the amount of the resin adhering to the terminal fitting is more suppressed.

(5) In the connector of any one of (1) to (4), a dimension in the width direction of the recess is constant over the entire length in the press-fitting direction of the press-fitting hole. According to this configuration, a complicated mold is not required in forming the press-fit hole.

### Details of Embodiment of Present Disclosure

An embodiment of the present disclosure is described below with reference to the drawings. The present disclosure is not limited to these illustrations, but is represented by claims and intended to include all changes in the scope of claims and in the meaning and scope of equivalents.

### Embodiment

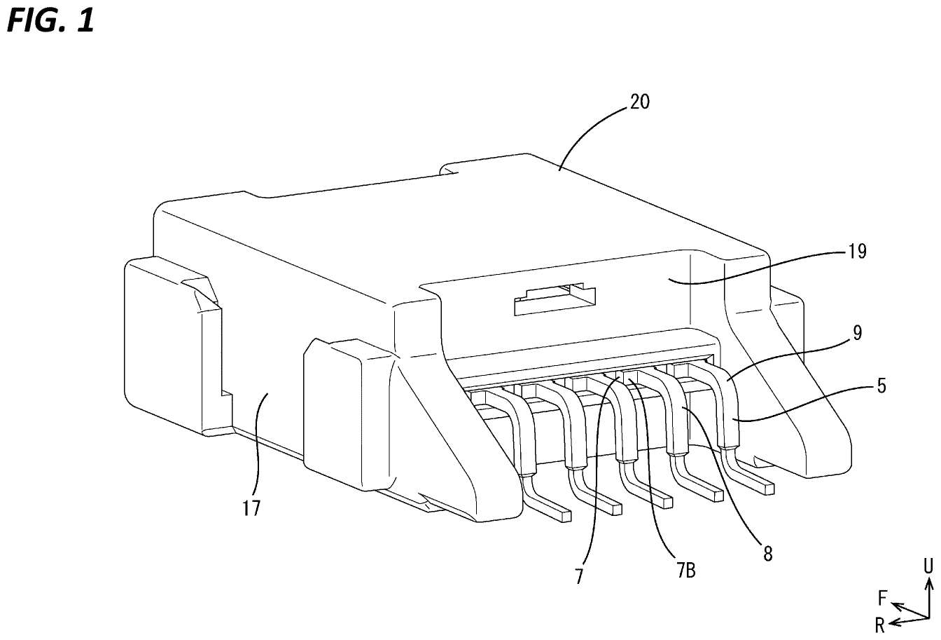

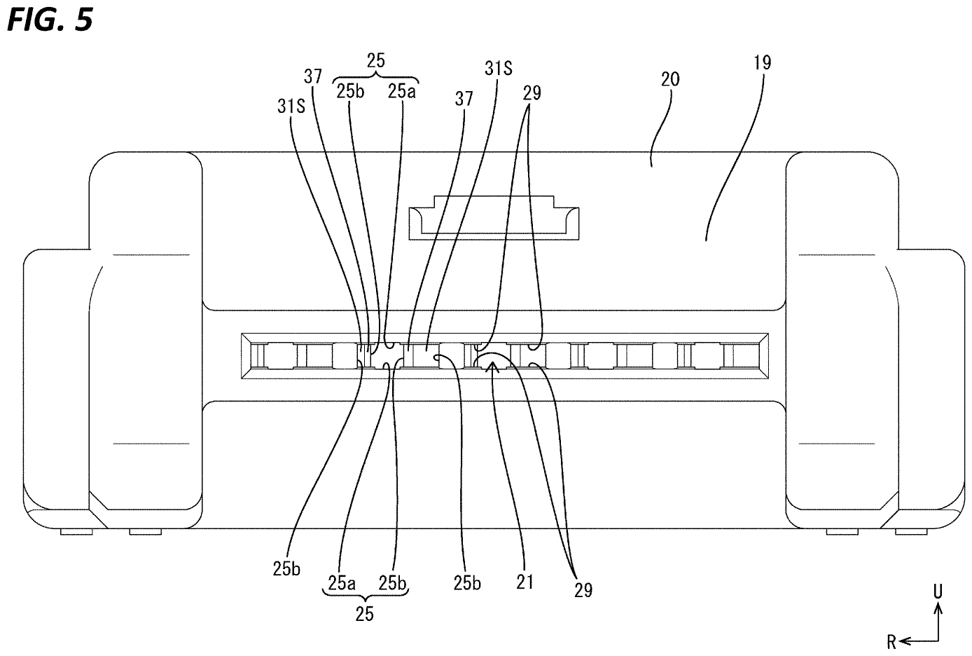

A connector 10 of one embodiment of the present disclosure is provided with a plurality of terminal fittings 5 and a housing 20 for mounting the respective terminal fittings 5. The connector 10 is a board connector to be mounted on a circuit board 50. The housing 20 is connectable to a mating housing 60. Note that, in the following description, a “front side” is denoted by “F” in FIGS. 1, 2, 3 and 9, concerning a front-rear direction. An “upper side” is denoted by “U” in FIGS. 1, 2 and 4 to 9, concerning a vertical direction. A “right side” is denoted by “R” in FIGS. 1 and 3 to 9, concerning a lateral direction.

### Housing 20

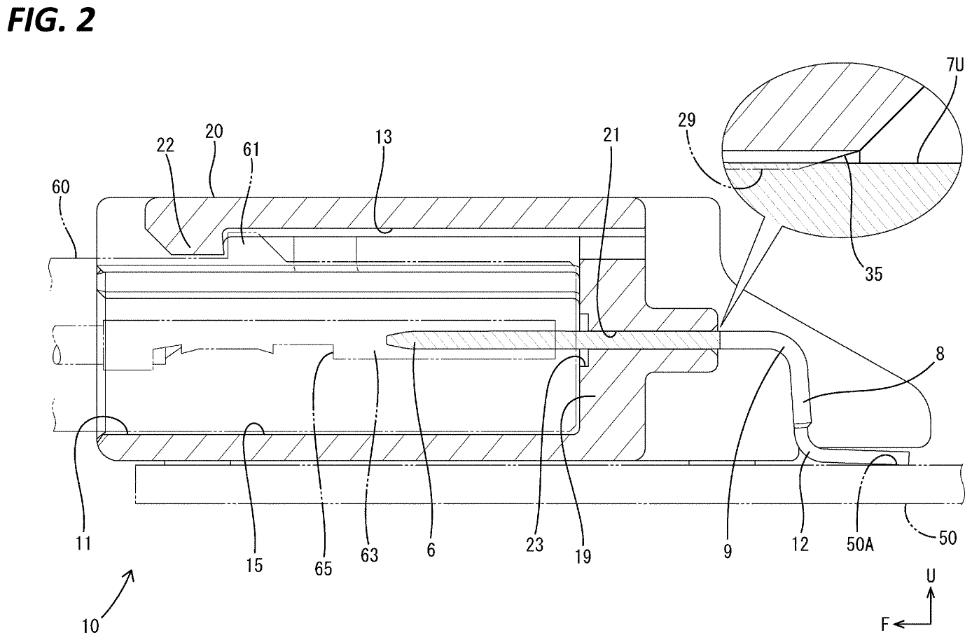

The housing 20 is made of synthetic resin and includes a receptacle 11 in the form of a flat rectangular tube elongated in a width direction. As shown in FIG. 2, the mating housing 60 is fittable into the receptacle 11.

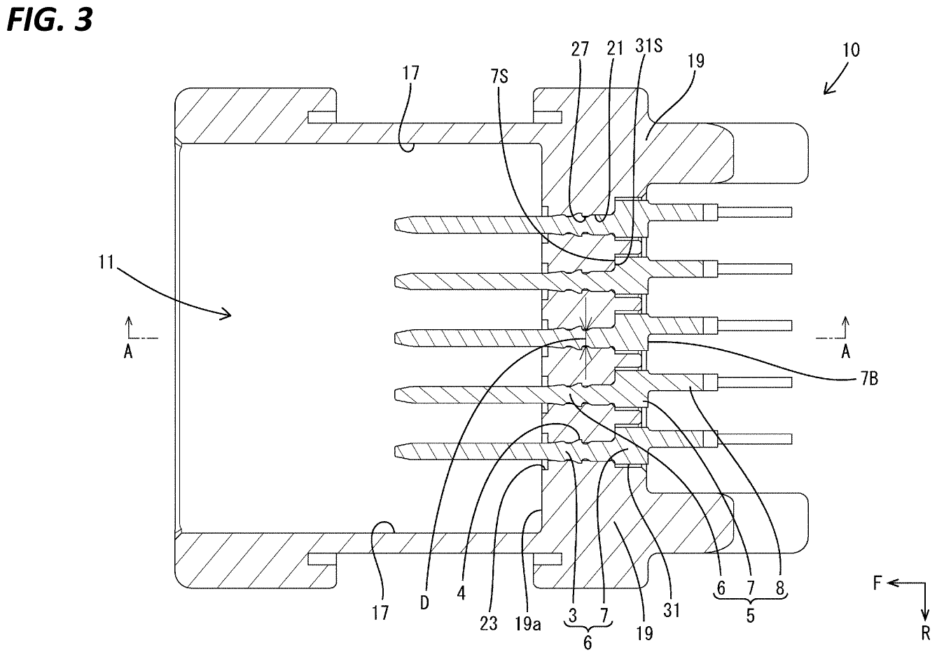

As shown in FIGS. 2 and 3, the receptacle 11 includes a pair of an upper wall 13 and a lower wall 15 arranged in the vertical direction and a pair of side walls 17 arranged in the lateral direction. A rear end part of the receptacle 11 is formed with a holding wall portion 19 connected to the rear ends of the upper wall 13, the lower wall 15 and the pair of side walls 17. The holding wall portion 19 is a part having a wall thickness direction oriented in the front-rear direction and holds the plurality of terminal fittings 5. The holding wall portion 19 includes a plurality of press-fitting holes 21 penetrating through the holding wall portion 19 in the wall thickness direction (front-rear direction). The terminal fitting 5 is press-fit into the press-fitting hole 21 from behind the housing 20.

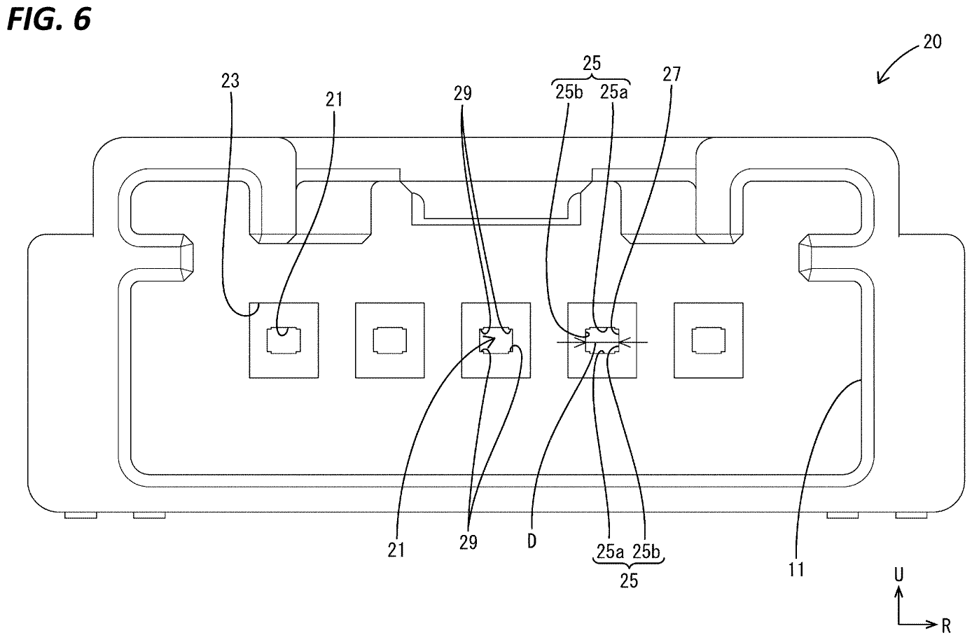

As shown in FIG. 3, a front surface 19a of the holding wall portion 19 facing the inside of the receptacle 11 is formed with storing portions 23 shaped by being shallowly recessed and having a rectangular front view shape when the housing 20 is viewed from front. As shown in FIG. 6, the plurality of press-fitting holes 21 are all located in the storing portions 23.

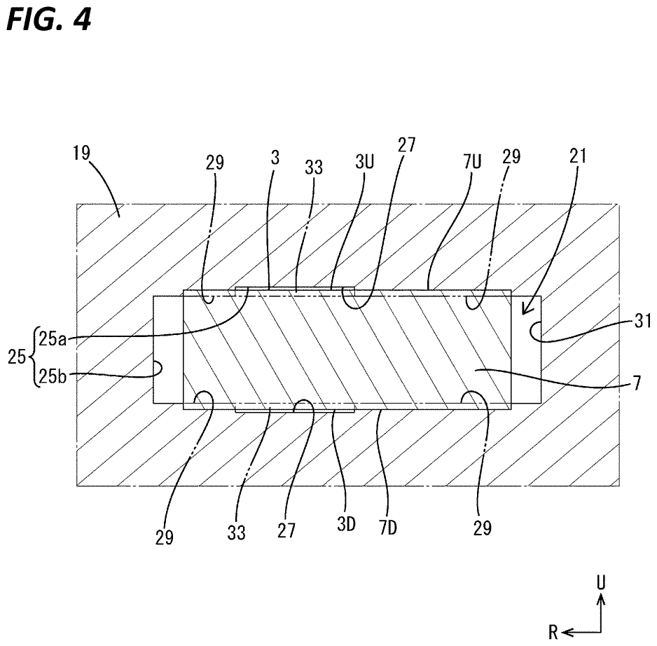

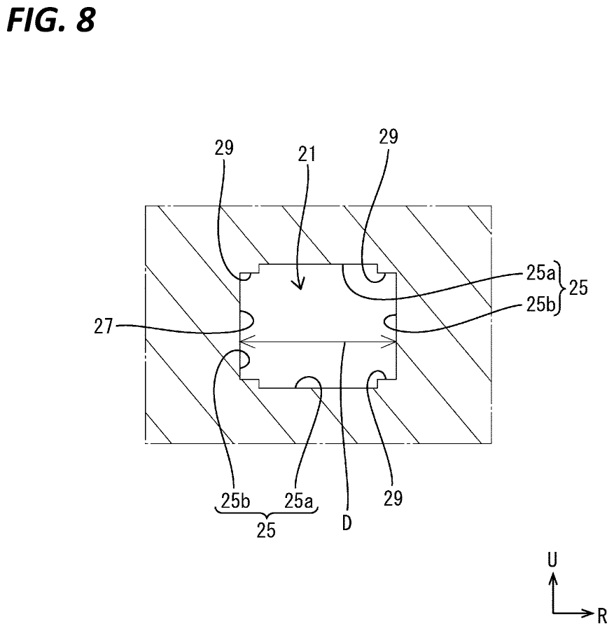

As shown FIGS. 4 and 8, the press-fitting hole 21 is formed by inner walls 25 on four sides. The inner walls 25 are composed of a pair of upper and lower first inner walls 25a parallel to each other and a pair of left and right second inner walls 25b parallel to each other. The inner wall 25 has a rectangular front view shape. The press-fitting hole 21 is composed of a reference width portion 27 constituting a front end region of the press-fitting hole 21 and a wide width portion 31 having a larger dimension in a width direction than the reference width portion 27 and constituting a rear end part of the press-fitting hole 21. Both left and right end parts of the wide width portion 31 are located outward of the reference width portion 27 in the lateral direction. The inner surfaces of the reference width portion 27 and those of the wide width portion 31 are constituted by the pair of first inner walls 25a and the pair of second inner walls 25b. A facing interval between the pair of second inner walls 25b in the reference width portion 27 is defined as a reference width D. The reference width D is substantially equal to a lateral width of a narrow portion 3 of the terminal fitting 5 to be described later. The reference width portion 27 has a substantially rectangular column shape extending in the front-rear direction.

The wide width portion 31 has a rectangular shape having a dimension in the width direction larger than a dimension in the front-rear direction in a plan view of the housing 20 from above. The wide width portion 31 has a flat rectangular parallelepiped shape.

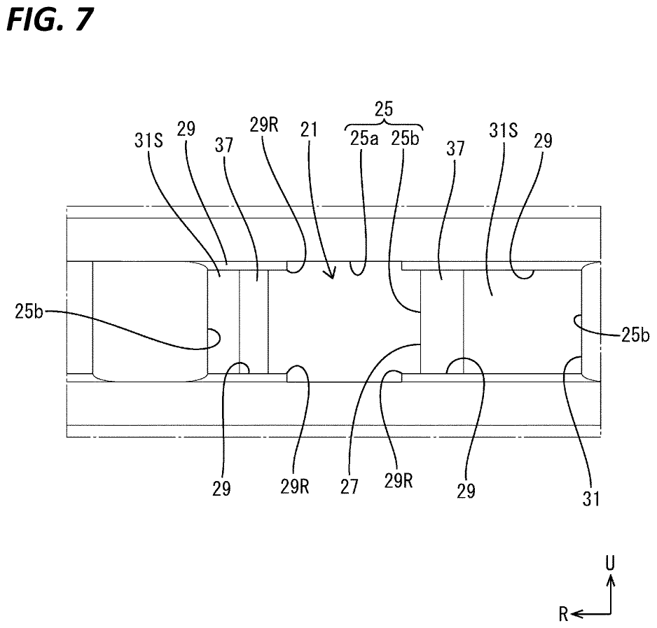

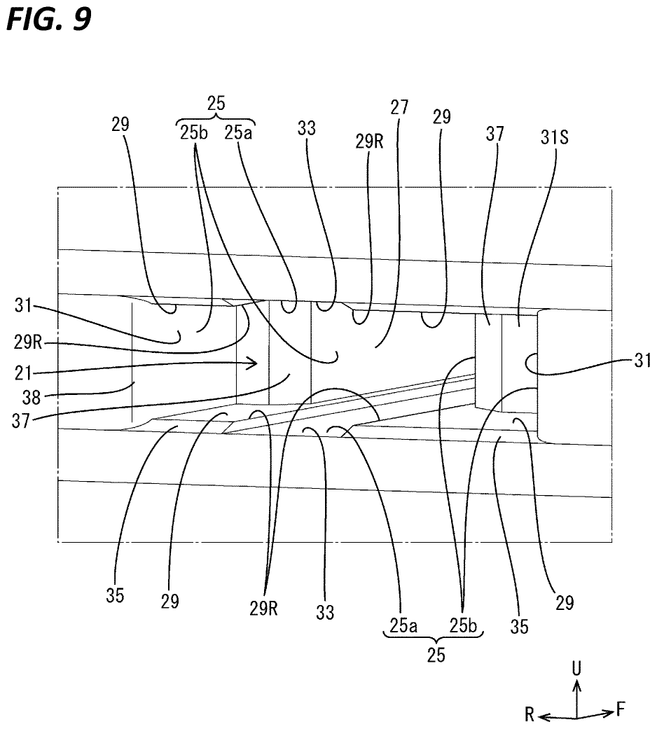

As shown in FIGS. 7 and 9, the pair of upper and lower first inner walls 25a constituting the press-fitting hole 21 are continuous and flush in the reference width portion 27 and the wide width portion 31. A facing interval between the pair of left and right second inner walls 25b constituting the reference width portion 27 is narrower than a facing interval between the pair of left and right second inner walls 25b constituting the wide width portion 31. The second inner walls 25b constituting the reference width portion 27 and the second inner walls 25b constituting the wide width portion 31 extend in the front-rear direction while being parallel to each other.

As shown in FIGS. 7 and 9, inclination suppressing portions 29 are formed on four corners in a front view of the inner walls 25 constituting the reference width portion 27. Corner portions 29R continuous with the inclination suppressing portions 29 of the reference width portion 27 are formed on four corners in a front view of the inner walls 25 constituting the wide width portion 31. These inclination suppressing portions 29 are arranged on both left and right end parts of the pair of upper and lower first inner walls 25a, and formed into a step shape in a front view. The corner portion 29R of the inclination suppressing portion 29 formed into a step shape continuously extends straight from a front end part of the reference width portion 27 to a rear end part of the wide width portion 31. These four corner portions 29R extend in parallel to each other from the front end to the rear end of the press-fitting hole 21.

Recesses 33 are formed in central parts in the width direction of the pair of upper and lower first inner walls 25a. The recess 33 is a space formed between a pair of the inclination suppressing portions 29 arranged at an interval in the width direction. The recess 33 is continuously formed over the entire length in the front-rear direction of the inclination suppressing portion 29. A width of the recess 33 is constant over the entire length in the front-rear direction of the press-fitting hole 21 (recess 33). In the process of press-fitting the terminal fitting 5 into the press-fitting hole 21, the inner surface of the recess 33 does not contact the terminal fitting 5. A rear end part of the inclination suppressing portion 29 is formed with a tapered guiding surface 35. The guiding surfaces 35 are parts for guiding the terminal fitting 5 shifted in position in the vertical direction with respect to the press-fitting hole 21 into the press-fitting hole 21 when the terminal fitting 5 is press-fit into the press-fitting hole 21.

First inclined surfaces 37 inclined to expand an interval between the second inner walls 25b are formed on rear end parts of the pair of second inner walls 25b constituting the reference width portion 27. Second inclined surfaces 38 inclined to expand the interval between the second inner walls 25b are formed on rear end parts of the pair of second inner walls 25b constituting the wide width portion 31. The first and second inclined surfaces 37, 38 are parts for guiding the terminal fitting 5 shifted in position in the lateral direction with respect to the press-fitting hole 21 into the press-fitting hole 21 when the terminal fitting 5 is press-fit into the press-fitting hole 21.

As shown in FIG. 2, the lock portion 22 of the housing 20 and the mating lock portion 61 of the mating housing 60 are locked to each other, whereby the housing 20 and the mating housing 60 are held in a connected state and each terminal connecting portion 6 is connected to a mating terminal 63 mounted in the mating housing 60. The mating terminal 63 is a female terminal fitting including a tubular box portion 65 and contacts the terminal connecting portion 6. The rear end of the board connecting portion 8 of each terminal fitting 5 is connected to a mounting surface 50A of the circuit board 50 by soldering. The board connecting portion 8 includes a part extending rearward via a second bent portion 12 and to be connected to the circuit board 50 by soldering on a lower end part.

### Terminal Fitting 5

The terminal fitting 5 is made of electrically conductive metal and formed by bending an elongated plate material having a substantially rectangular transverse cross-section substantially at a right angle at each of two positions. As shown in FIGS. 1 and 2, the terminal fitting 5 includes the terminal connecting portion 6 extending straight in the front-rear direction and the board connecting portion 8 connected to the terminal connecting portion 6. The board connecting portion 8 is connected to the rear end of the terminal connecting portion 6 via a first bent portion 9 and extends downward from the first bent portion 9. The board connecting portion 8 is L-shaped in a side view of the terminal fitting 5 and connected to the circuit board 50. Gold plating (not shown) is applied to the surface of the terminal fitting 5 to improve electrical connection to the mating terminal 63.

As shown in FIG. 3, the terminal connecting portion 6 includes the narrow portion 3 constituting a front end part of the terminal connecting portion 6 and the wide portion 7 constituting a rear end part of the terminal connecting portion 6. The narrow portion 3 is in the form of a plate long in the front-rear direction. A width of the narrow portion 3 is substantially equal to the reference width portion D. A rear end part of the narrow portion 3 includes a press-fitting projection 4 protruding in the width direction intersecting a press-fitting direction. A width of the press-fitting projection 4 is slightly larger than the reference width portion D. With the terminal fitting 5 press-fit in the press-fitting hole 21, a rear end part formed with the press-fitting projection 4, out of the narrow portion 3, is located in the reference width portion 27. The wide portion 7 is arranged to be connected to the rear end of the narrow portion 3. A plan view shape of the wide portion 7 is a substantially square shape having a width larger than the reference width portion D. The wide portion 7 has a substantially rectangular parallelepiped shape having a width larger than the reference width portion D. With the terminal fitting 5 press-fit in the press-fitting hole 21, the wide portion 7 is accommodated in the wide width portion 31.

As shown in FIG. 4, in a back view, the inclination suppressing portions 29 of the wide width portion 31 are in contact with both left and right end parts of an upper surface 7U of the wide portion 7 and both left and right end parts of a lower surface 7D of the wide portion 7. Contact regions of the wide portion 7 and the inclination suppressing portions 29 of the wide width portion 31 extend from the front end to the rear end of the wide width portion 31. The inclination suppressing portions 29 of the reference width portion 27 are in contact with both left and right end parts of an upper surface 3U of the narrow portion 3 and both left and right end parts of a lower surface 3D of the narrow portion 3. Contact regions of the narrow portion 3 and the inclination suppressing portions 29 of the reference width portion 27 extend from the front end to the rear end of the reference width portion 27.

### Functions and Effects of Connector 10

The connector 10 of the present disclosure is mounted on the circuit board 50 with the terminal fittings 5 mounted in the housing 20. When the terminal fitting 5 is mounted into the housing 20, the narrow portion 3, which is a front end region of the terminal fitting 5, is press-fit into the press-fitting hole 21 formed in the holding wall portion 19 from behind the housing 20. Press-fitting is performed by pressing a rear end surface 7B of the wide portion 7 of the terminal fitting 5. In a press-fitting process, a front end part of the narrow portion 3 enters the wide width portion 31. The both left and right end parts of the upper surface 3U of the narrow portion 3 and those of the lower surface 3D contact the inclination suppressing portions 29 in the wide width portion 31. At this time, if the terminal fitting 5 is shifted upward or downward with respect to the press-fitting hole 21, the both left and right end parts of the narrow portion 3 slide in contact with the tapered guiding surfaces 35, whereby a position shift of the terminal fitting 5 is corrected.

If the terminal fitting 5 is further press-fit after the narrow portion 3 enters the wide width portion 31, the narrow portion 3 enters the reference width portion 27 while the upper and lower surfaces thereof are sandwiched by the inclination suppressing portions 29. At this time, even if the terminal fitting 5 is shifted in position in the lateral direction with respect to the reference width portion 27, the front end of the narrow portion 3 is smoothly guided to the reference width portion 27 by the first inclined surfaces 37 formed in the reference width portion 27.

If the terminal fitting 5 is further press-fit, the surfaces of the inclination suppressing portions 29 made of synthetic resin are scraped by friction with the both left and right end parts of the both upper and lower surfaces of the narrow portion 3 made of metal and the resin adheres to the surface of the narrow portion 3. However, the inclination suppressing portions 29 are formed only on both end parts in the width direction of the press-fitting hole 21. Thus, a widthwise central part of the narrow portion 3 is kept facing the recesses 33 and, therefore, kept out of contact with the inclination suppressing portions 29 (first inner walls 25a). In this way, the resin does not adhere to the widthwise central part of the narrow portion 3. That is, in the connector 10 of this embodiment, the amount of the resin adhering to the surface of the terminal fitting 5 in the press-fitting process is reduced by providing the recesses 33. In this way, the connection reliability of the terminal fitting 5 and the mating terminal 63 can be ensured. Further, since a slide-contact area of the narrow portion 3 with the first inner walls 25a is reduced by providing the recesses 33, friction resistance generated in the press-fitting process of the terminal fitting 5 is reduced.

In a final stage of the press-fitting process, the wide portion 7 enters the wide width portion 31. The upper and lower surfaces 7U, 7D of the wide portion 7 contact the inclination suppressing portions 29 of the wide width portion 31. At this time, even if the terminal fitting 5 is slightly inclined in the vertical direction, the terminal fitting 5 is guided into the wide width portion 31 by the slide contact of the front end edges of the both left and right end parts of the wide portion 7 with the tapered guiding surfaces 35.

If the terminal fitting 5 is further press-fit from the above state, the front end of the narrow portion 3 passes through the press-fitting hole 21 and projects into the receptacle 11 of the housing 20. If the terminal fitting 5 is further press-fit forward, a front end surface 7S of the wide portion 7 butts against a front end surface 31S of the wide width portion 31 as shown in FIG. 3, thereby restricting the press-fitting (forward movement) of the terminal fitting 5. In the above way, the press-fitting process of the terminal fitting 5 into the press-fitting hole 21 is completed. In the press-fitting process of the terminal fitting 5, the widthwise central parts of the both upper and lower surfaces of the wide portion 7 are not in contact with the first inner walls 25a in the wide width portion 31 due to the recesses 33 formed between the pairs of inclination suppressing portions 29. Therefore, the adhesion of the resin to the wide portion 7 is suppressed and friction resistance at the time of press-fitting is reduced.

The connector 10 is mounted on the circuit board 50 by reflow. Specifically, the board connecting portion 8 of each terminal fitting 5 is placed on pasty solder cream applied to the surface of the circuit board 50 and, in that state, the connector 10 and the circuit board 50 are heated in an unillustrated reflow furnace. The solder is melted and integrated with the board connecting portion 8 by being heated. Thereafter, by cooling and solidifying the solder, the board connecting portions 8 are conductively fixed to a circuit of the circuit board 50.

If the housing 20 is heated in the reflow furnace, a lateral central part of the housing 20 is, for example, deformed to curve upward and the terminal fittings 5 may be inclined in the vertical direction with respect to the holding wall portion 19 according to the deformation of the housing 20. If the terminal fitting 5 is inclined with respect to the housing 20, there is a concern that the board connecting portion 8 of the terminal fitting 5 is separated from the circuit board 50 to cause a connection failure between the board connecting portion 8 and the circuit board 50. However, in the case of this embodiment, since the inclination suppressing portions 29 extend from the front end to the rear end of the press-fitting hole 21 to sandwich the terminal fitting 5 in the vertical direction, it can be suppressed that the terminal fitting 5 is inclined in the vertical direction with respect to the housing 20 in a reflow process. In this way, a possibility that the board connecting portion 8 is separated from the circuit board 50 to cause a connection failure is reduced. In the above way, the assembly of the connector is completed.

The connector 10 of this embodiment is provided with the housing 20 made of synthetic resin and the terminal fittings 5 made of metal. The housing 20 includes the holding wall portion 19 formed with the press-fitting holes 21 in the form of through holes. The terminal fitting 5 includes the board connecting portion 8 to be surface-mounted on the circuit board 50 and is press-fit into the press-fitting hole 21 from behind the holding wall portion 19. The press-fitting hole 21 is composed of the reference width portion 27 constituting the front end region of the press-fitting hole 21 and the wide width portion 31 having a larger dimension in the width direction than the reference width portion 27 and constituting the rear end part of the press-fitting hole 21. The terminal fitting 5 includes the narrow portion 3 to be accommodated into the reference width portion 27 and the wide portion 7 to be accommodated into the wide width portion 31. The first inner walls 25a of the reference width portion 27 and the wide width portion 31 are formed with the inclination suppressing portions 29 for suppressing the inclination of the terminal fitting 5 with respect to the holding wall portion 19 by contacting the outer surface of the terminal fitting 5. In this way, the inclination suppressing portions 29 and the terminal fitting 5 contact each other, whereby the inclination of the terminal fitting 5 in a thickness direction caused according to the thermal expansion of the housing at the time of reflow can be suppressed. In this way, it can be prevented that the board connecting portion 8 of the terminal fitting 5 is lifted from the circuit board 50 to cause a connection failure in the reflow process.

In the connector 10 of this embodiment, the rear end part of the inclination suppressing portion 29 is formed with the tapered guiding surface 35 for guiding the terminal fitting 5. According to this configuration, the terminal fitting 5 is smoothly guided into the press-fitting hole 21 and the position shift of the terminal fitting 5 with respect to the press-fitting hole 21 can be corrected by the tapered guiding surfaces 35. Since the connector 10 undergoes the reflow process with the terminal fittings 5 press-fit at proper positions with respect to the press-fitting holes 21, the position shifts of the terminal fittings 5 with respect to the circuit board 50 can be effectively suppressed in the reflow process.

In the connector 10 of this embodiment, the inclination suppressing portions 29 are formed only on the both end parts in the width direction of the press-fitting hole 21. The recesses 33 configured not to contact the terminal fitting 5 are formed in the widthwise central parts of the first inner walls 25a constituting the press-fitting hole 21. According to this configuration, when the terminal fitting 5 is press-fit into the press-fitting hole 21, the central parts in the width direction of the inner surfaces do not contact the terminal fitting 5. Thus, as compared to the case where the inclined surfaces 29 are held in contact with the terminal fitting 5 over the entire width of the first inner walls 25a, the amount of the resin adhering to the terminal fitting 5 is suppressed and a connection failure to the mating terminal 63 due to resin adhesion to the terminal fitting 5 can be suppressed.

In the connector 10 of this embodiment, the recesses 33 are continuously formed over the entire length in the press-fitting direction of the press-fitting hole 21 (inclination suppressing portions 29). According to this configuration, since the terminal fitting 5 and the recesses 33 are not in contact over the entire lengths of the arranged inclination suppressing portions 29 in the press-fitting direction into the press-fitting hole 21, the amount of the resin adhering to the terminal fitting 5 is more suppressed.

In the connector 10 of this embodiment, the dimension in the width direction of the recess 33 is constant over the entire length in the press-fitting direction of the press-fitting hole 21 (inclination suppressing portions 29). According to this configuration, a complicated mold is not required in forming the press-fitting hole 21.

### Other Embodiments of Present Disclosure

The embodiment disclosed this time should be considered illustrative in all aspects, rather than restrictive.

(1) In the embodiment, the corner portions 29R of the pair of inclination suppressing portions 29 formed on the both left and right end parts of the first inner wall 25a extend in parallel to each other from the front to rear ends of a space where the reference width portion 27 is formed and a space where the wide width portion 31 is formed. The corner portions 29R of the pair of inclination suppressing portions 29 may be formed in a part of the space where the reference width portion 27 is formed or may be formed in a part of the space where the wide width portion 31 is formed.

(2) In this embodiment, the corner portions 29R of the pair of inclination suppressing portions 29 formed on the both left and right end parts of the first inner wall 25a vertically symmetrically extend in the front-rear direction in the pair of first inner walls 25a. The corner portions 29R of the pair of inclination suppressing portions 29 formed on the both left and right end parts of the upper first inner wall 25a may extend in parallel to each other from the front to rear ends of the reference width portion 27 and the wide width portion 31, and the corner portions 29R of the pair of inclination suppressing portions 29 formed on the both left and right end parts of the lower first inner wall 25a may only extend from the front to rear ends of the wide width portion 31.

(3) The corner portions 29R of the pair of inclination suppressing portions 29 formed on the both left and right end parts of the first inner wall 25a extend straight in parallel to each other from the front and rear ends of the space where the reference width portion 27 is formed and the space where the wide width portion 31 is formed. The corner portions 29R of the pair of inclination suppressing portions 29 formed on the both left and right end parts of the first inner wall 25a may be formed to extend straight in parallel to each other in the space where the reference width portion 27 is formed and extend straight in parallel to each other over a lateral width larger than the reference width D in the space where the wide width portion 31 is formed.

(4) In this embodiment, the inclination suppressing portions 29 are formed only on the both left and right end parts of the pair of upper and lower first inner walls 25a. The inclination suppressing portions 29 may be formed on the both left and right end parts and the central parts of the pair of first inner walls 25a and recesses may be formed between the inclination suppressing portions 29 formed on the both left and right end parts and the inclination suppressing portions 29 formed in the central parts. Further, the inclination suppressing portions 29 may be formed on the both left and right end parts of the upper first inner wall 25a and formed only in the central part of the lower first inner wall 25a.

(5) In this embodiment, the inclination suppressing portions 29 contact the outer surface of the terminal fitting 5 to sandwich the terminal fitting 5 from substantially vertically upward and downward directions with respect to the width direction. The inclination suppressing portions 29 may contact the outer surface of the terminal fitting 5 from either an upward direction or a downward direction with respect to the width direction.

### List of Reference Numerals

3 . . . narrow portion

3D . . . lower end surface of narrow portion

3U . . . upper end surface of narrow portion

4 . . . press-fitting projection

5 . . . terminal fitting

6 . . . terminal connecting portion

7 . . . wide portion

7B . . . rear end surface of wide portion

7D . . . lower end surface of wide portion

7S . . . front end surface of wide portion

7U . . . upper end surface of wide portion

8 . . . board connecting portion

9 . . . first bent portion

10 . . . connector

11 . . . receptacle

12 . . . second bent portion

13 . . . upper wall

15 . . . lower wall

17 . . . side wall

19 . . . holding wall portion

19a . . . front end surface of holding wall portion

20 . . . housing

21 . . . press-fitting hole

22 . . . lock portion

23 . . . shaving storing portion

25 . . . inner wall

25a . . . first inner wall (inner surface)

25b . . . second inner wall

27 . . . reference width portion

29 . . . inclination suppressing portion

29R . . . corner portion

31 . . . wide width portion

31S . . . front end surface of wide width portion

33 . . . recess

35 . . . guiding surface

37 . . . first inclined surface

38 . . . second inclined surface

50 . . . circuit board

50A . . . mounting surface

60 . . . mating housing

61 . . . mating lock portion

63 . . . mating terminal

65 . . . box portion

D . . . reference width

1. A connector, comprising:
a housing made of synthetic resin, the housing including a holding wall portion; and
a terminal fitting including a board connecting portion to be surface-mounted on a circuit board,
the holding wall portion being formed with a press-fitting hole penetrating through the holding wall portion in a front-rear direction,
the terminal fitting being press-fit into the press-fitting hole from behind the holding wall portion,
the press-fitting hole including a reference width portion constituting a front end region of the press-fitting hole and a wide width portion having a larger dimension in a width direction than the reference width portion, the wide width portion constituting a rear end part of the press-fitting hole,
the terminal fitting including a narrow portion to be accommodated into the reference width portion and a wide portion to be accommodated into a wide width portion,
an inner surface of the reference width portion and an inner surface of the wide width portion being formed with inclination suppressing portions for suppressing inclination of the terminal fitting with respect to the holding wall portion by contacting an outer surface of the terminal fitting in a direction intersecting the width direction,
the inclination suppressing portions being formed only one both end parts in the wd of the inner surfaces, and
a width of a front end part of the narrow portion being so set that the front end part of the narrow portion contacts the inclination suppressing portions of the wide width portion in a process of press-fitting the terminal fitting into the press-fitting hole.

2. The connector of claim 1, wherein a tapered guiding surface is formed on a rear end part of the inclination suppressing portion.

3. The connector of claim 1, wherein recesses configured not to contact the terminal fitting are formed in central parts in the width direction of the inner surfaces.

4. The connector of claim 3, wherein the recess is continuously formed over an entire length in a press-fitting direction of the press-fitting hole.

5. The connector of claim 4, wherein a dimension in the width direction of the recess is constant over the entire length in the press-fitting direction of the press-fitting hole.
